(19) United States
(12) Patent Application Publication
(10) Pub. No.: US 2025/0273216 A1
(43) Pub. Date: Aug. 28, 2025

(54) DYNAMIC COMMUNICATION TRANSFORMATION

(71) Applicant: T-MOBILE INNOVATIONS LLC, Overland Park, KS (US)

(72) Inventors: Wilfred I. TUCKER, Centennial, CO (US); Joseph Reid BAIRD, Kent, WA (US)

(21) Appl. No.: 18/590,764

(22) Filed: Feb. 28, 2024

(51) Int. Cl. G10L 15/30; G10L 13/02; G10L 15/26

(52) U.S. Cl. CPC G10L 15/30; G10L 13/02; G10L 15/26

(57) ABSTRACT

Embodiments of the present disclosure are directed to systems and methods for converting communications from one form to another based on a set of user preferences. A user device may receive a communication in a first form, and based on a set of user preferences associated with the user device, the communication in the first form may be converted to a second form. For example, a first user device may communicate a text communication to a second user device. Said text communication may then be converted into an audio communication based on the user preference. By way of another example, a first user device may communicate an audio communication to a second user device. Said audio communication may then be converted into a text communication based on the user preferences.

### SUMMARY

The present disclosure is directed to systems and methods for dynamically transforming communications communicated from a first user device to a second user device.

According to various aspects of the technology, a first user device may transmit a communication to a second user device in any first form. Said second user device may receive that communication in the first form and then convert said communication to a second form. In further embodiments, the second user device may receive the communication in a second form, wherein the communication was converted either by the first user device or a server associated with a communication network. This conversion to a second form may be made based on a set of user preferences associated with the second user device which may be stored in association with any or all of the first user device, the server, or the second user device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example of a computer environment, in accordance with one or more embodiments;

FIG. 2 depicts a diagram of a network environment, in accordance with one or more embodiments;

FIG. 3 is a flow chart of a method for network communication, in accordance with one or more embodiments;

FIG. 4 is a flow chart of a computer readable media configured for network communication, in accordance with one or more embodiments;

FIG. 5 is a flow chart of a system for network communication, in accordance with one or more embodiments.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a user of a telecommunication service has multiple methods by which they can transmit information from their user device to other user devices. These communications can take the form of a voice call, voice message, voice memo, or other audio based communications. They may also take the form of a text message, email, or other text based communications. Different forms of communication are delivered to user devices and consumed through distinct applications such as a message center or a voicemail inbox. Each of these forms of communication are treated as distinct by current generation devices.

Conventionally, when a first user of a telecommunications network desires to send a communication to a second user, the form in which the first user chooses to send said communication is the form in which the second user will receive that communication. For example, if a user types out a text message to send to a second user, the second user will receive that message as a text message. If a first user attempts to call the second user over a voice line, if that second user does not pick up, that second user will receive an audio voicemail. The preferences of the originator of the communication, also called the mobile originating (MO) terminal device/initiator of a communication is the only preference taken into account when that communication is transmitted to a second user. Transformation of communications is possible by the mobile terminating user device (MT), but requires additional applications, processing power and user interaction. In some instances, it may be desirable for the MT to receive or output information in a different form than what was initiated by the MO. For example, when the MT is on a bandwidth-constrained network, the MT may only be able to receive certain forms of communication (e.g., SMS messages) but not others (e.g., voice calls). Therefore, the MT may not receive a communication initiated by the MO that is in unsupported form. Similarly, it may be preferable to display or otherwise output information at the MT in a different form than what was originated by the MO without the use of additional applications. For example, if the MT receives a text message from the MO but a user of the MT prefers voice messages, the user of the MT would need to manually change the text message to a voice message using a text to voice application. This requires additional steps and additional memory and processing power from the MT. Similarly, if the MT receives a voice message from the MO, but the user of the MT prefers a text message, the user of the MT would also need to manually change the voice message to text as above.

Unlike Conventional solutions, the present disclosure provides a solution which allows an MT to dictate how information is received or output by the MT. The present disclosure provides an environment in which an MO may prepare and send a communication to an MT in a first form (e.g., voice memo, text message, email, voicemail, etc.) and the MT may then designate a different, second form in to receive or output said communication. Additionally, these preferences may be set such that communications are automatically converted without the need for additional interaction by the MT. A further embodiment of the solution includes the MT generating a notification that a message has been received in a certain format. This notification may be interacted with to convert the message into a different format. For example, the MT may receive a voice message. The MT may then generate a notification which may be interacted with. Based on the interaction with the notification, the MT may convert the received message into a different format. Finally, the present disclosure may also provide for the use of AI technologies in the transformation of audio information and provides for a unique graphical user interface in which a user may interact with all forms of communications.

Accordingly, a first aspect of the present disclosure is directed to a method for network communication comprising receiving a text communication at a user device associated with a set of user preferences. The method further comprises determining, by the user device, an output form for the communication based on the set of user preferences associated with the user device, wherein the output is an audio communication. The method further comprises converting the text communication into the audio communication based on the set of user preferences.

A second aspect of the present disclosure is directed to a computer-readable storage media having computer-executable instructions embodied thereon that, when executed by one or more processors, cause the one or more processors to receive an audio communication at a user device associated with a set of user preferences. The computer-executable instructions further determine, by the user device, an output form for the communication based on the set of user preferences associated with the user device, wherein the output form is a text communication, and convert the audio communication into the text communication based on the set of user preferences.

Another aspect of the present disclosure is directed to a system for network communication, the system comprising one or more computing processing components. The one or more computer processing components are configured to perform operations comprising receiving a message in a first form, and determining that a set of user preferences is associated with a second user device, wherein the set of user preferences indicates a preference to consume the message in a second form. The one or more computer processing components are further configured to, based on the set of user preferences, convert the message from the first form to the second form, and communicate the message in the second form.

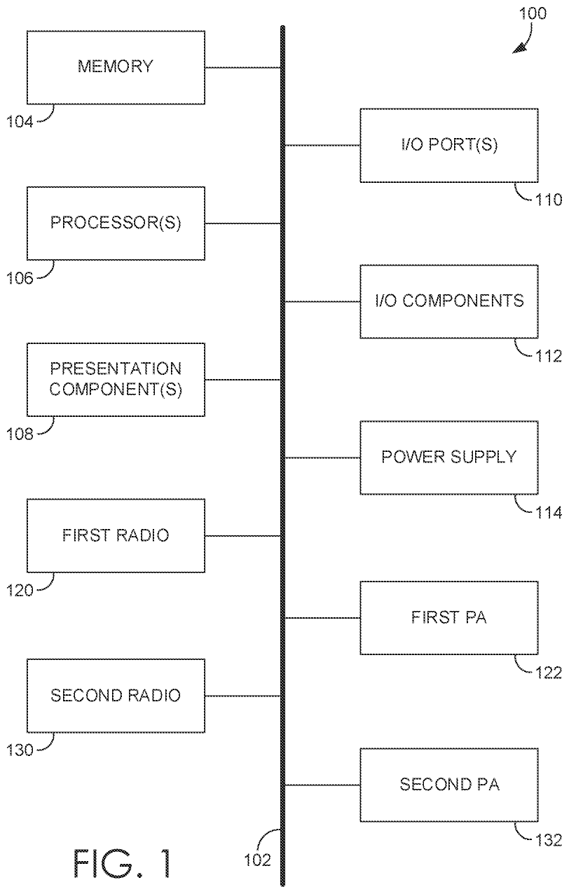

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to a an access point and receive one or more signals from the access point (or some other access point); the computing device 100 may be referred to herein as a user equipment, wireless communication device, or user device, The computing device 100 may take many forms; non-limiting examples of the computing device 100 include a cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate with a wireless network on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VOIP communications. In aspects, the first radio 120 and the second radio 130 may be configured to communicate using the same protocol but in other aspects they may be configure dot communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies.

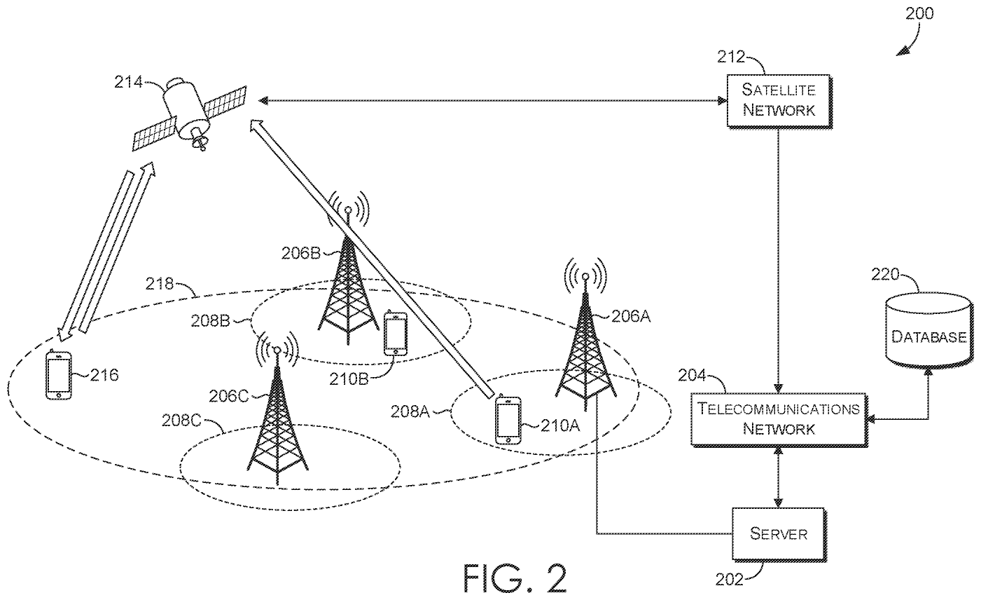

FIG. 2 depicts an example of a network environment 200, in accordance with one or more embodiments. The network environment 200 includes a server 202 having one or more processors. The server 202 operates within and thus is communicatively coupled to a telecommunications network 204 or its components. The server 202 is communicatively coupled to one or more base stations 206A, 206B, and 206C within the telecommunications network 204. Each of the one or more base stations 206A, 206B, and 206C has a corresponding coverage areas 208A, 208B, and 208C. The one or more base stations 206A, 206B, and 106C can provide telecommunications services to one or more user devices 210A and 210B. One or more user devices 210A and 210B may be such a device represented by computing environment 100.

In the network environment 200 shown, the telecommunications network 204 interfaces with satellite network 212, which is also referred to as an aerospace network. In one aspect, the server 202 operates as, or is communicatively coupled to, a telecommunications core network component that acts as an interface between the satellite network 212 and the telecommunications network 204. The satellite network 212 can include one or more devices configured to act as aerospace access points, such as satellite 214. Although not shown, the satellite network 212 may interface with and communicate with one or more terrestrial radio elements that are not associated with the telecommunications network 204. The satellite 214 can provide connectivity to a user device 216 that is located within the coverage area 218 of the satellite 214.

In aspects, the user device 210A that is located within coverage area 208A communicates with the base station 206A, such that the base station 206A provides the user device 210A with connectivity to and services of the telecommunications network 204. In one such aspect, the user device 210A sends communications to the base station 206A over an uplink channel. Meanwhile, the user device 216 that is located within the coverage area 218 may send communications to the satellite 214 over an uplink channel. These communications of the user device 216 may be transmitted using the same particular radio frequencies designated for the uplink channel, and which are being used by the user device 210A to communicate with the base station 206A. Due to the proximity and/or at least a partial overlap of the coverage area 218 of the satellite 214 with the coverage area 208A of the base station 206A, the use of the same radio frequencies by the user device 210B and the user device 210A can allow for communication between coverage areas. That being said, when a user device 216 are communicating through a satellite 214, there may be reductions in bandwidth such that communications with user devices (such as user devices 210B and 210A) associated with terrestrial base stations (such as base stations 206A, 206B, and 206C) are affected.

In embodiments which include some form of bandwidth reduction such as the embodiment discussed above, an audio communication may be converted to a text communication. This conversion may for example be accomplished in real-time. For example, the MT may be located in an area where the MTis only connected to a satellite 214, such as when the MT is traveling on an airplane. In said situation, the network to which the MT is connected may be bandwidth constrained. Using conventional methods, if an MO were to attempt to communication with the MT which is connected to a bandwidth constrained network, the communication may fail, particularly if the MT's connection to the bandwidth constrained network only permits one type of communication (e.g., SMS) and the MO originated a non-compliant communication type (e.g., voice call). Or, the MO may send a notification to the MT that a communication was attempted. Further, under conventional methods, he MO may get a notification that the communication was attempted but unable to be accomplished.

In contrast to how conventional communications sessions are handled, aspects of the present disclosure provide for an MT which may convert the audio communication that was attempted to be transmitted, such as a phone call, to a text communication. This conversion could be accomplished in real-time. In embodiments in which the conversion is accomplished in real-time, said communication may be accomplished through the use of artificial intelligence (AI). For example, the MO may connect to the MT over a bandwidth constrained connection. The MO may receive audio information from the user of the MO such as a voice call. This audio communication may be converted by the MO, or by the server 202, or any other device associated with the telecommunications network 204 such that before the MT receives the communication, it is converted to a text communication. In the embodiment of real-time conversion, this received text communication may be displayed as a string of text information that is provided to the user of the MT by way of a graphical user interface of the MT. Therefore the user of the MT may be able to consume the information provided by the MO even under bandwidth constraints which may limit the ability for the MT to receive audio communication. AI can not only be used for the real-time conversion of audio to text and text to audio, but may be used for various additional embodiments. For example, an MT who receives a text communication from an MO may convert that text communication into an audio communication which is representative of the human voice of the user of the MO. This may be accomplished through voice modeling AI.

In embodiments, the user of the MO may provide a number of audio voice recordings through the use of an audio recording application. These audio voice recordings may then be processed by a voice modeling AI which may then create a voice model for the user of the MO. This voice model may then be provided to the MT. This may allow the MT to convert text communications received from the MO to an audio communication representative of the user of the MO's voice through the use of the voice model. In further embodiments, the MO may store the model of the user of the MO's voice and communicate the converted audio representative of the user of the MO's voice along with the text communications to the MT. This may allow the MT to play the text communication as an audio communication in the user of the MO's voice without needing to store the user of the MO's voice model on the MT. In embodiments, the user of the MT may also provide a number of audio vice recordings which may be used to convert text messages communicated form the MT to other user devices.

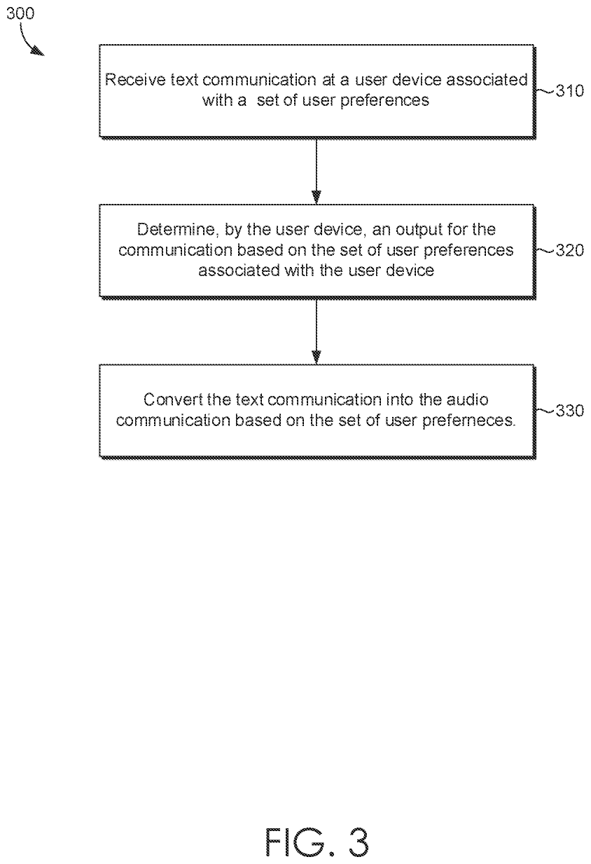

Turning now to FIG. 3 a flow chart is provided for a method 300 for network communications. At a first step 310, a text communication is received at a user device associated with a set of user preferences. In embodiments, the text communication can be delivered over a cellular network similar to the network environment 200 of FIG. 2. The text communication may also be delivered over various other methods such as Wi-Fi, Bluetooth communications, or any other form of wireless communication. In embodiments, the user preferences associated with the user device may indicate any number of preferences associated with the user device. For example, the user preferences may indicate that the user associated with the user device prefers not to receive text communications. In said example, when a text communication is received by the user device, the user device may determine that the text communication needs to be converted to some other form of communication. The user preferences may also indicate that the user of the user device is to be notified when a text communication is received.

This notification may come in a number of forms, for example, a push notification on the user device. This notification may be displayed on a graphical user interface associated with the user device and provide one or more options which may be selected by the user. These options may indicate a request to convert the text communication to an audio communication. Based on a selection of the notification by the user, the user device may convert the text communication to an audio communication. The user preference may also indicate a preference which automatically determines that a text communication is being communicated. And, based on that determination, convert the text communication to an audio communication without further input by the user.

At a second step 320, an output for the communication is determined, by the user device, based on the set of user preferences associated with the user device, wherein the output form is an audio communication. This determination may be made by the MT, the MO that originated the communication, or any other device associated with the network environment 200 involved in the transmission of the communication. In embodiments, the output is determined by an MO. In further examples, the user preferences are stored in association with the MT (which is referred to as “the user device” for the flow diagram of FIG. 3). Additionally, the user preferences of the user device or any other user device associated with a network environment 200 may be stored in association with a server 202 or data base 220 as shown in FIG. 2.

At a third step 330, the text communication is converted into the audio communication based on the set of user preferences. This conversion may occur at various different stages of communication and may occur at various devices throughout the various stages of the communication. For example, the MO may have the preferences of various MTs stored in association with the MO. In said example, the text communication may be converted into the audio communication by the MO prior to the text communication being communicated to the MT. In further examples, the user preferences may be stored by a database 220 or server 202 associated with the network environment 200. In said example, the conversion from text communication to audio communication may be accomplished by the server 202 associated with the network environment 200.

As such, a text communication may be communicate from an MO, and between being communicated from the MO and received by the MT, the text communication may be converted to an audio communication in the network environment 200. This conversion could take place at the server 202 or any other computing device associated with the network environment 200. In said example, this conversion may be accomplished through the use of user preferences stored in association with an MT, an MO, or a server 202 or database 220 associated with the network environment 200. In further examples, the set of user preferences may be stored in association with the MT. In said example, the text communication may be delivered to the MT without any further actions by the user of the MO or use of the MO.

In examples, the text communication may be converted to an audio communication through the use of an artificial intelligence or machine learning model (the model used to converted a text communication to an audio communication representative of a user of an MO's vocal sounds and patterns is referred to as the AI model herein). In various embodiments, audio communications provided by a user of the MO to an MO may be used to generate an AI model that may be used to convert a text communication into an audio communication representative of the user of the MO's vocal sounds and patterns. This AI model may then be used in the conversion of a text communication transmitted from the MO to various MTs. This provides an embodiment in which the audio communication converted from the text communication is representative of the vocal sounds and patterns of the MO who transmitted the text communication. In various embodiments, this AI model may be stored in association with the MO, the MT, the database 220 or server 202 of the network environment 200, or any other computing devices associated with the network environment 200.

Additionally, once the text communication has been received by the user device, the user device may cause display of an indication that the text communication has been received. If the user preferences indicate a preference to automatically convert text communications to audio communications, the user device may display an indication that the text communication has been converted to an audio communication. As discussed in various examples and embodiments above, the conversion from text communication to audio communication may be accomplished through the use of an AI model. In said examples, the text communication may be communicated to the MT with the AI model attached to the text communication, or may send the proper AI generated voice communication, converted through the use of the AI model at a substantially similar time to the MT. In further embodiments, if the AI model is stored in association with other computing devices of the network environment 200, the AI model may be used to convert the text communication to the audio communication representative of the user of the MO's voice between the transmission from the MO to the receipt of the communication by the MT.

Additionally, the user device may provide the audio communication to the MT in various ways. The user device may display, on a graphical user interface associated with the user device, an indication that the text communication has been received by the user device, or that the text message has automatically been converted to an audio communication. As discussed above, this converted audio communication may be created through the use of an AI model and therefore representative of a user of the MO's vocal sounds and patterns. The indication may comprise a selectable graphical user interface element that once selected, plays the audio communication in a form that is consumable by the user of the MT.

Additionally, the selection of the selectable graphical user interface element may cause a change in the graphical user interface. For example, the user of the MT may select the graphical user interface through the user of a touch screen associated with the user device, and based on this selection, the graphical user interface may be caused to display a new graphical user interface. This new graphical user interface may provide information associated with the text communication which has been received or converted to the audio communication. The new graphical user interface may also display information associated with various other text communications or audio communications received by the user device. This new graphical user interface may provide a number of selectable options which once selected, may perform various tasks. For example, this graphical user interface may provide selectable options which once selected, may play an audio communication, may display a text communication, or may convert a text communication into an audio communication. Further, this new graphical user interface may provide various selectable elements related to various AI models stored in association with the user device. By selecting these AI model selectable elements, the user may cause various text communications to be converted into audio communications representative of vocal sound and patterns associated with the users who's audio communications were used in creation of the AI models. As such, the displaying, playing, or converting of an audio or text communication may all be accomplished through the selection of elements of the graphical user interface.

By way of an illustrative example, a user of an MT may specify through a user preference which is preset that they only wish to consume audio communications, or only wishes to consume text communications. For example, a user of an MO may prepare and send a text message to an MT. The user of the MT may have a preference set which indicates that they only wish to receive and consume voice messages. In said example, the communication delivered to the MT will be converted from a text communication to a voice communication, without the need for further interaction by either the user of the MO or the user of the MT. In various embodiments, the MO's message may be in any format and the resulting communication consumed by the user of the MT may be in any format, based on the preferences associated with the MT.

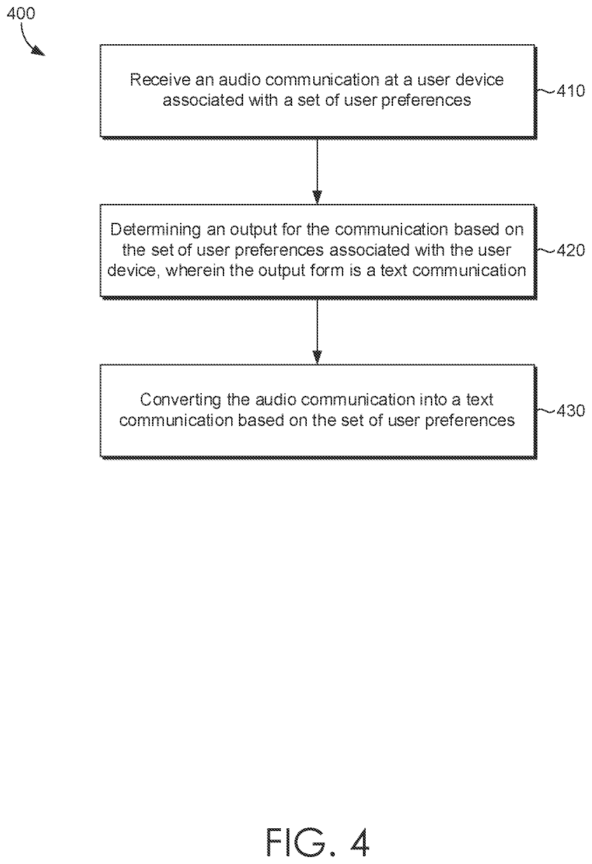

Turning to FIG. 4, an additional flow chart is provided for a computer readable media having computer-executable instructions embodied thereon, that, when executed by one or more processors, cause the one or more processors to perform a set of steps 400. At a first step 410, an audio communication is received at a user device associated with a set of user preferences. Similar to that discussed above, these user preferences may be stored in association with the user device, an MO, or other computing device associated with the network environment 200. Further, these user preferences may indicate a preference to automatically convert audio communications to text communications no matter the preferences associated with the MO or the contents of the audio communication. In additional embodiments, the user preferences may indicate that a notification is to be displayed on the graphical user interface when an audio communication is received by the user device. This notification may provide a selectable graphical user interface which may cause display of the text communication, cause the audio communication to be played through speakers associated with the user device, or may cause display of the new graphical user interface as discussed in detail above. Additional notifications may be displayed in the new graphical user interface which once selected may cause display of information associated with the MO that communicated the audio communication, or may provide the option to convert received audio communications to a text communication.

At a second step 420, an output for the communication is determined based on the set of user preferences associated with the user device, wherein the output form is a text communication. And, at a third step 430, the audio communication is converted into a text communication based on the set of user preferences. This conversion may be accomplished through the use of AI voice to text models which use machine learning to transform spoken words into viewable text without the need for further interactions by users. In embodiments, the converted text communication may automatically be displayed on a graphical user interface associated with the user device without any further interactions by the user associated with the user device. Or as discussed above, may cause display of the new graphical user interface through which the converted text communication may be viewed by the user.

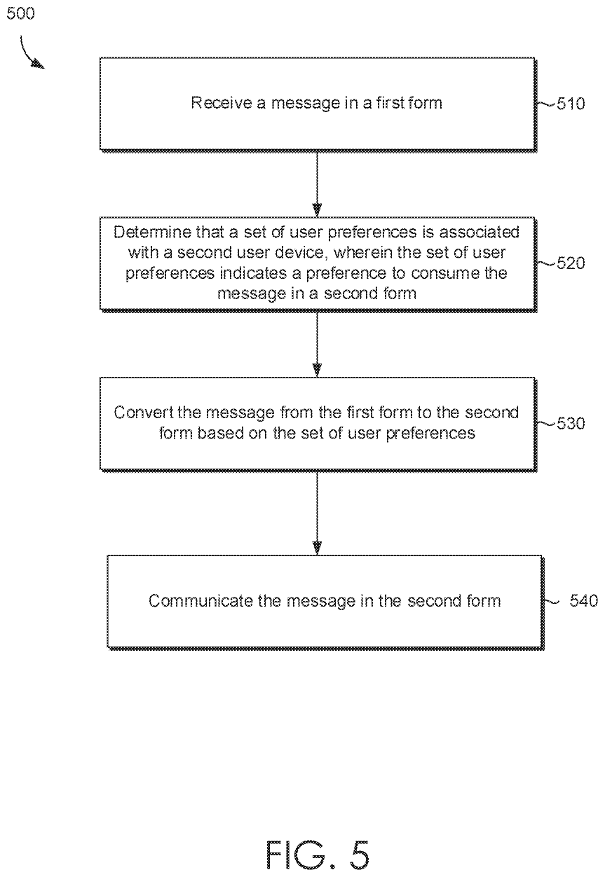

Turning to FIG. 5, a flow chart is provided for a system 500 for network communication. The system comprises one or more computer processing components which are configured to perform a set of operations, also referred to as steps. At a first step, 510, a message is received in a first form. The first form may be a text communication, audio communication, or any other form of communication transmitted from an MO to an MT. At a second step 520, it is determined that a set of user preferences is associated with a second user device, wherein the set of user preferences indicates a preference to consume the message in a second form. The set of user preferences may be any of those discussed throughout, additionally, the second form may be a text communication, audio communication, or any other form of communication transmitted form an MO to an MT. At a third step, 530, the message is converted from the first form to the second form based on the set of user preferences. This conversion from a first form to a second form may comprise any of the conversion discussed throughout, and may be converted at any stage of the communication, also as discussed throughout. And, at a fourth step, 540, the message is communicated in its second form. In embodiments, communicating the message in its second form may comprise converting the message at the MO prior to the message being transmitted. This may also comprise transmitting the message from an MO to a network environment 200 in which the message is converted prior to being received by the MT. Further, this may comprise transmitting the message with an indication that it is to be converted to a second form. In said embodiments, the conversion may take place at the MT either through the use of data transmitted with the message, or through the use of data stored in association with the MT.

In further embodiments, AI detection software may be used to determine if an audio communication received by an MT is an AI generated voice, or a genuine audio communication transmitted by an MO. Herein, genuine audio communication describes an audio communication received from an MO associated with the audio communication. In embodiments, this audio communication could have originated as a text communication, and through the use of an AI model associated with the MO, converted to an audio communication. If the text communication originated from the MO, the resulting converted audio communication would be determined to be a genuine audio communication. If the text message that resulted in an audio communication representative of a user of the MO's vocal patters, was not communicated by the MO, then the audio communication would be determined not to be a genuine audio communication. In embodiments, AI models stored in association with an MT, or other computing devices associated with the network environment 200 may be used to determine if an audio communication received by the MT is a genuine audio communication from an MO associated with that AI model. If the audio communication is determined not to be a genuine audio communication, the MT may cause display of a notification indicating that the audio communication is not a genuine audio communication. If the audio communication is determined to be a genuine audio communication, the MT may cause display of a notification indicating that the audio communication is a genuine audio communication. This determination may be made by assessing the differences and similarities between the audio communication and an AI model stored in association with the MT, or other computing devices associated with the network environment 200. This determination may also be made by determining the address from which the audio communication is transmitted. If the audio communication is transmitted from a user device that is not associated with the MO who's AI model was used to convert or create the audio communication, it may be determined that the audio communication is not a genuine audio communication.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for network communication, the method comprising:
receiving a text communication at a user device associated with a set of user preferences;
determining, by the user device, an output form for the text communication based on the set of user preferences associated with the user device, wherein the output form is an audio communication; and
converting the text communication into the audio communication based on the set of user preferences.

2. The method of claim 1, wherein the converting further comprises generating an artificial intelligence model of a set of vocal sounds and vocal patterns associated with a first user.

3. The method of claim 2, wherein the converting further comprising generating the audio communication based on the artificial intelligence model.

4. The method of claim 3, further comprising determining the audio communication is a genuine audio communication.

5. Computer-readable storage media having computer-executable instructions embodied thereon that, when executed by one or more processors, cause the one or more processors to:
receive an audio communication at a user device associated with a set of user preferences;
determine, by the user device, an output form for the audio communication based on the set of user preferences associated with the user device, wherein the output form is a text communication; and
convert the audio communication into the text communication based on the set of user preferences.

6. The computer-readable storage media of claim 5 further comprising:
cause display of the text communication on a graphical user interface associated with the user device.

7. The computer-readable storage media of claim 5, further comprising:
cause display of a notification on a graphical user interface indicating that the audio communication has been converted to the text communication.

8. The computer-readable storage media of claim 7, wherein receiving a selection of the notification causes display of the text communication.

9. The computer-readable storage media of claim 7, wherein receiving a selection of the notification causes display of a new graphical user interface associated with a set of text and audio communications.

10. A system for network communication, the system comprising:
one or more computer processing components configured to perform operations comprising:
receiving a message in a first form;
determining that a set of user preferences is associated with a second user device, wherein the set of user preferences indicates a preference to consume the message in a second form;
based on the set of user preferences, converting the message from the first form to the second form; and
communicating the message in the second form.

11. The system of claim 10, wherein the first form is an audio communication.

12. The system of claim 11, wherein the second form is a text communication.

13. The system of claim 12, wherein converting the message from the first form to the second form comprises converting the audio communication to the text communication.

14. The system of claim 10, wherein the first form is a text communication.

15. The system of claim 14, wherein the second form is an audio communication.

16. The system of claim 15, wherein converting the message from the first form to the second form comprises converting the text communication to the audio communication.

17. The system of claim 16, wherein the converting further comprises generating the audio communication based on an artificial intelligence model associated with a first user.

18. The system of claim 17, wherein the artificial intelligence model is generated based on a set of audio recordings associated with the first user.

19. The system of claim 18, wherein the audio communication generated based on the artificial intelligence model comprises a set of vocal sounds and patterns associated with the first user.

20. The system of claim 19, further comprising determining that the audio communication is a genuine audio communication.
